(19) United States
(12) Patent Application Publication
(10) Pub. No.: US 2009/0198590 A1
(43) Pub. Date: Aug. 6, 2009

(54) INDUSTRIAL-DESIGN-RESOURCES OPERATING PLATFORM

(76) Inventors: Li-ming HU, Taichung city (TW); Yung-ming Wang, Taichung city (TW)

Correspondence Address: SINORICA, LLC, 2275 Research Blvd., Suite 500, ROCKVILLE, MD, 20850, US

(21) Appl. No.: 12/111,220

(22) Filed: Apr. 29, 2008

(30) Foreign Application Priority Data
Jan. 31, 2008 (TW) 097103658

(51) Int. Cl. G06Q 30/00

(52) U.S. Cl. 705/26

(57) ABSTRACT

An industrial-design-resources operating platform locates at a server end for connecting buyers and designers at client ends via the internet. The industrial-design-resources operating platform comprises a primary storage module for storing at least one first industrial design draft sent by the designer; a resource depository module for depositing an industrial design work which is an evaluated classification generated by having the first industrial design draft evaluated by at least one evaluator; a pricing module for giving a price to the industrial design work according to the evaluated classification; a displaying module for showing the priced industrial design work to a plurality of said buyers; and a purchasing module for accepting purchase fees paid by the buyers.

### BACKGROUND OF THE INVENTION

1. Technical Field

The present invention relates to an industrial-design-resources operating platform, and more particularly to an industrial-design-resources operating platform that connects buyers and designers at client ends via the internet to facilitate transaction.

2. Description of Related Art

As technologies progress, a consumer who wishes to buy a product no longer needs to follow a traditional transaction mode and go shopping at a physical store with cash in hand. A transaction can be made via e-commerce instead. The so-called e-commerce, or electronic commerce, is conducted through the Internet, whereby commercial activities such as selling and buying as well as products and services are integrated, wherein traditional cash flows and product flows are digitized to shorten transaction time and reduce costs. From a consumer's perspective, a variety of products can be bought through e-commerce without the limitation of time and space. From an enterprise's perspective, expensive rents for stores and expenses such as personnel costs can be saved through e-commerce. Consequently, a plurality of electronic transaction platforms have emerged as e-commerce becomes more and more popular.

Nowadays, the best known electronic transaction platform is provided by e-Bay, where tens of thousands of products are circulated each day and consumers' needs can be satisfied via group price-negotiation and an online payment mechanism. In addition, U.S. Pat. No. 6,988,658 discloses a transaction platform that can track consumer behaviors to promote transaction opportunities. Such electronic transaction modes have been gradually adopted by different industries.

To the industry of industrial design, however, the aforementioned electronic transaction platforms cannot apply as they are, mainly because industrial design works have such different properties from those of general products, that a direct application of the foregoing electronic transaction platforms cannot promote transactions of industrial design. First of all, the quality of a general product can be easily identified by a buyer, and its price usually reflects actual conditions of the product, so that the product can be traded in either the traditional or the electronic transaction mode without any difficulties. In contrast, the quality of an industrial design work is related to its concept and often determined through evaluation by a more advanced designer, or through awards received in design competitions, thereby determining a buyer's purchase price of the industrial design work indirectly. Hence, if a design work from a seller is circulated on an electronic transaction without prior evaluation of its quality, it is hard to arouse a buyer's purchase intention. Secondly, a general product has a physical existence. Therefore, even though a buyer has examined the product on a transaction platform, the buyer cannot obtain the product if its price is not paid. However, an industrial design work is intended mainly to provide its buyer with an intangible design concept. A buyer who has examined the industrial design work on a transaction platform can obtain the design concept through visual memory without paying for it, which is quite unfair to the seller. Thirdly, a general product is manufactured by a very complicated process, in which it is difficult for a buyer to participate. Therefore, even though a product does not satisfy a buyer's need completely, the buyer will have no choice but accept the product. On the other hand, an industrial design work is not intended to be bought by a general consumer, but in most cases, a manufacture of a certain product. When an industrial design work from a seller does not satisfy the manufacture's need completely, the manufacture can improve and add value to the design work to meet the need. Nevertheless, existing transaction platforms provide no such function to a buyer of industrial design works, and therefore little incentive for the buyer to purchase industrial design works. In light of the above, the successful experience of electronic transaction platforms cannot be transferred completely to the industrial design industry. As a result, transactions of industrial design works are still performed in a traditional cash-negotiation mode.

### BRIEF SUMMARY OF THE INVENTION

In order to overcome the shortcomings of the prior art, the present invention provides an industrial-design-resources operating platform, located at a server end, for connecting a buyer and a designer at client ends via the internet, thereby promoting transaction. The industrial-design-resources operating platform comprises a primary storage module for storing at least one first industrial design draft sent by the designer; a resource depository module for depositing an industrial design work which is an evaluated classification generated by having the first industrial design draft evaluated by at least one evaluator; a pricing module for giving a price to the industrial design work according to the evaluated classification; a displaying module for showing the priced industrial design work to a plurality of said buyers, and after accepting purchase requests from the buyers, granting different browsing authorities to the buyers, wherein the buyers having the different browsing authorities are authorized to browse a plurality of said industrial design works under different classifications; and a purchasing module for accepting purchase fees paid by the buyers who have made the purchase requests.

Therefore, a primary objective of the present invention is to provide an industrial-design-resources operating platform, wherein buyers may pay different browsing fees according to different classifications of industrial design works in order to browse the industrial design works, thereby satisfying the buyers' different needs and promoting transaction opportunities in the industrial design industry.

Another objective of the present invention is to provide an industrial-design-resources operating platform, wherein a specific ratio of a purchase fee paid by a buyer is allocated to a seller to provide the seller with incentives to offer industrial design works, thereby promoting transaction opportunities in the industrial design industry.

Another objective of the present invention is to provide an industrial-design-resources operating platform which allows a designer to show industrial design works through a more convenient channel, thereby promoting transaction opportunities in the industrial design industry.

Another objective of the present invention is to provide an industrial-design-resources operating platform which offers evaluation and evaluated classifications of industrial design works in a more timely manner to promote transaction opportunities in the industrial design industry.

Another objective of the present invention is to provide an industrial-design-resources operating platform which provides a channel for adding commercial value to industrial design works, thereby promoting development of the industrial design industry.

### BRIEF DESCRIPTION OF THE SEVERAL VIEWS OF THE DRAWINGS

The invention as well as a preferred mode of use, further objectives and advantages thereof, will best be understood by reference to the following detailed description of illustrative embodiments when read in conjunction with the accompanying drawings, wherein:

FIG. 1A is a schematic drawing of an industrial-design-resources operating platform according to a first preferred embodiment of the present invention;

FIG. 1B is a schematic drawing of an industrial-design-resources operating platform according to a second preferred embodiment of the present invention;

FIG. 1C is a schematic drawing of an industrial-design-resources operating platform according to a third preferred embodiment of the present invention; and

FIG. 1D is a schematic drawing of an industrial-design-resources operating platform according to a fourth preferred embodiment of the present invention.

### DETAILED DESCRIPTION OF THE INVENTION

The present invention provides an industrial-design-resources operating platform that uses network communication technologies. As the network communication technologies used in the present invention can be readily understood by a person of ordinary skill in the art, a complete description thereof will be omitted herein. Besides, drawings referred to in the following description are not drawn according to actual dimensions and it is not necessary to do so because they are intended to demonstrate features of the present invention only schematically.

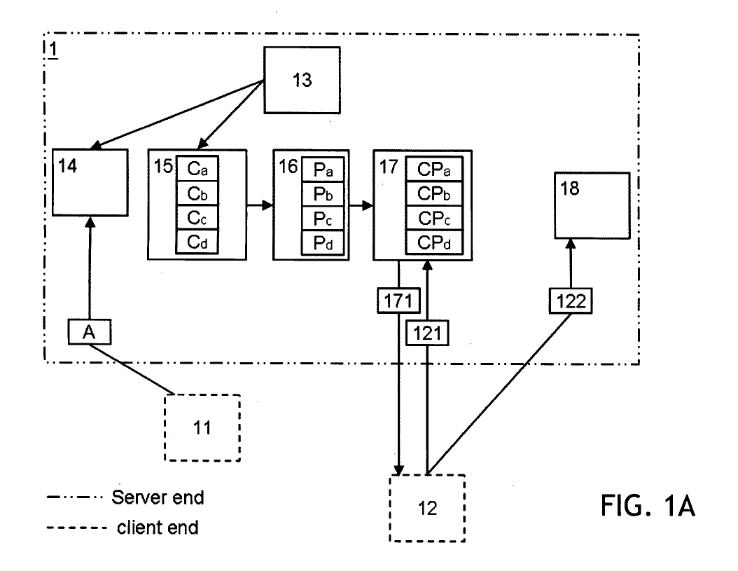

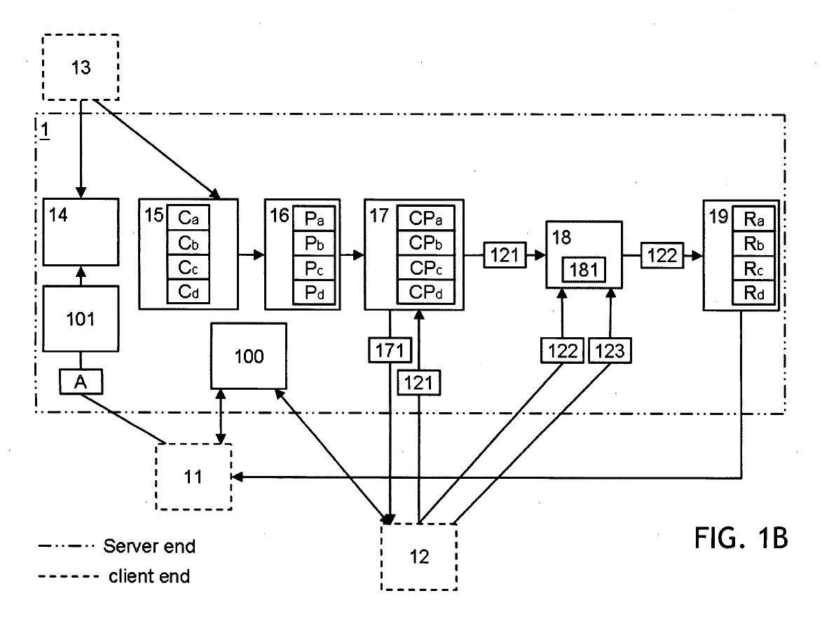

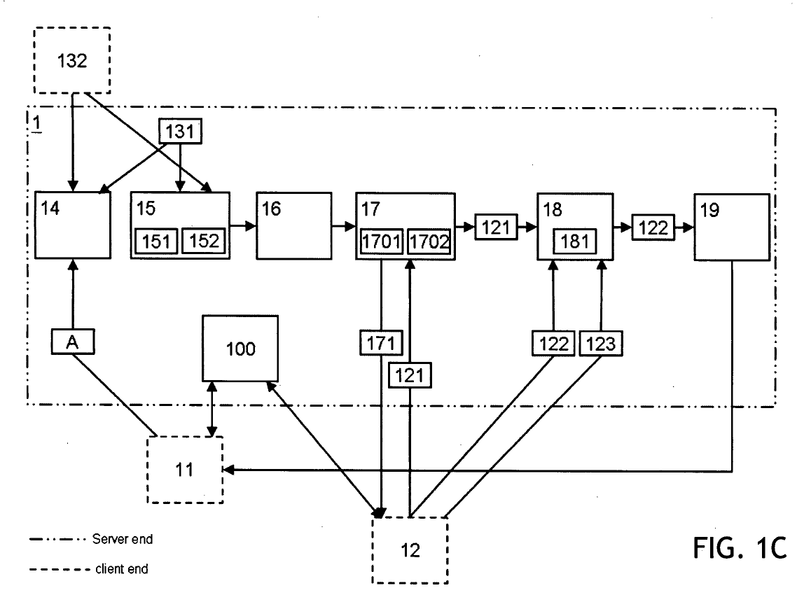

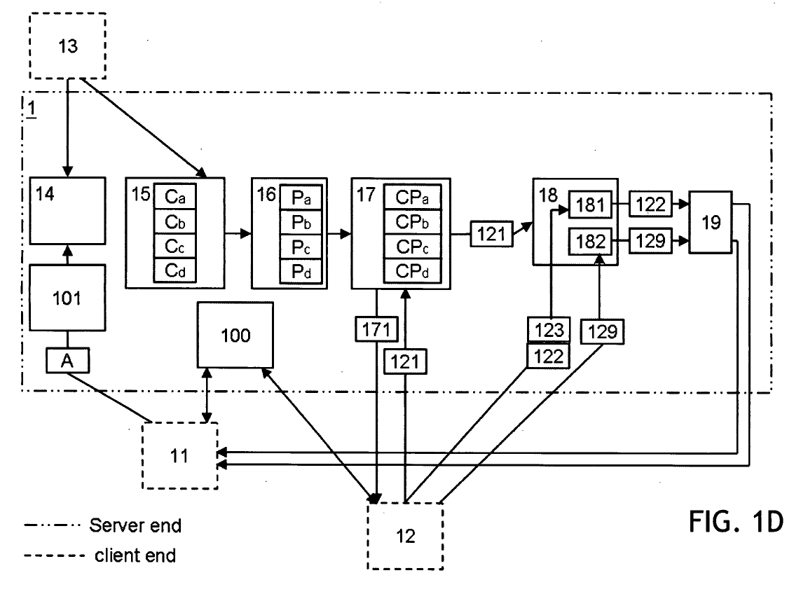

Referring to FIGS. 1A to 1C, an industrial-design-resources operating platform 1 according to preferred embodiments of the present invention is located at a server end for connecting a buyer 12 (or buyers) and a designer 11 (or designers) at client ends via the internet to promote a transaction. The industrial-design-resources operating platform 1 comprises a primary storage module 14, a resource depository module 15, a pricing module 16, a displaying module 17 and a purchasing module 18.

The primary storage module 14 is used to store at least one industrial design draft A sent by the designer 11, wherein the designer 11 can be a professional person or an ordinary one, while the industrial design draft A can be a draft that can be digitized data, a two-dimensional drawing, a three-dimensional drawing, an animation or a video. Of course, the industrial design draft A can also be a schematic drawing, a written description, a hand drawing, a conceptual diagram or a physical design diagram.

The resource depository module 15 is used to deposit an industrial design work C which corresponds to the industrial design draft A with an evaluated classification generated by at least one evaluator 13. The classification can be evaluated according to a degree to which a merchandising of the industrial design draft A has been realized, or according to the commercial potential, the market value, or the concrete level of the industrial design draft A. For example, after evaluation, the industrial design work C can be classified according to classifications a, b, c, d, etc. into Ca, Cb, Cc, Cd, etc., and then sent to the industrial-design-resources operating platform 1. The evaluator 13 can be located at the industrial-design-resources operating platform 1 at the server end, as shown in FIG. 1A. Alternatively, the evaluator 13 can be located at one of the client ends, as shown in FIG. 1B, and retrieve the industrial design draft A from the industrial-design-resources operating platform 1. Alternatively, some of the evaluators 13 can be located at the industrial-design-resources operating platform 1 at the server end, and the other evaluators can be located at the client ends. The pricing module 16 gives an appropriate price P, or more particularly Pa, Pb, Pc, Pd, etc., to the industrial design work C, according to the evaluated classification.

The displaying module 17 shows the priced industrial design work CP, and more particularly CPa, CPb, CPc, CPd, etc., to the buyers 12 according to the different classifications. The buyers 12 having the different browsing authorities 171 are authorized to browse different priced industrial design works CP under the corresponding different classifications.

Referring to FIG. 1B, the purchasing module 18 accepts purchase fees 122 paid by the buyers 12 who made the purchase requests 121. The purchasing module 18 can further comprise a verifying sub-module 181 for verifying qualifications of the buyers 12 who made the purchase requests 121 and the priced industrial design work CP they requested to purchase, before accepting the purchase fees 122 they pay. Meanwhile, the buyers 12 pay registration fees 123 of different levels to the purchasing module 18 in advance, in order to obtain different levels of the browsing authorities 171.

The industrial-design-resources operating platform 1 can further comprise a fee managing module 19 for profit sharing to allocate a specific ratio R, or more particularly Ra (10%), Rb (20%), Rc (30%), Rd (40%), etc., of the purchase fees 122 paid by the buyers 12 to the designer 11. The fee managing module 19 for profit sharing can also allocate some other specific ratio of the purchase fees paid by the buyers to the evaluator or the industrial-design-resources operating platform itself.

Referring again to FIG. 1B, the industrial-design-resources operating platform 1 can also comprise a certifying module 100, whereby the designer 11 is allowed to send the industrial design draft A only after the designer 11 is certified, and the buyers 12 are granted the correct browsing authorities 171 only after the buyers 12 are certified.

The industrial-design-resources operating platform 1 can further comprise a value-adding module 101 for adding value to a particular industrial design draft A (or some particular industrial design drafts), before the particular industrial design draft A is stored in the primary storage module 14 for the subsequent classification by the evaluator 13. Such “adding value” means to modify or re-design the industrial design draft A for improving its commercial potential, the market value, or the concrete level, so as to get a higher subsequent evaluated classification.

Referring to FIG. 1C, the evaluators 13 can further comprise at least one internal evaluator 131 and at least one external evaluator 132, wherein the internal evaluator 131 is located at the industrial-design-resources operating platform 1 at the server end, while the external evaluator 132 is located at one of the client ends. The resource depository module 15 can further comprise an internal resource depository module 151 for depositing the industrial design work evaluated by the internal evaluator 131; and an external resource depository module 152 for depositing the industrial design work evaluated by the external evaluator 132.

The displaying module 17 can comprise a first displaying sub-module 1701 for showing the priced industrial design work in the internal resource depository module 151, and a second displaying sub-module 1702 for showing priced the industrial design work in the external resource depository module 152.

Referring now to FIG. 1D, the industrial-design-resources operating platform 1 according to the present invention can further comprise another value-adding module 182 for accepting a buyer's 12 commission for value addition and a value-adding fee 129 the buyer 12 is willing to pay, and then adding value to the priced industrial design work CP purchased by the buyer 12, wherein the value can be added by, for example, providing a merchandized design, a structural design, a strength design, etc., so that the merchandising of the priced industrial design work CP is realized to a higher degree. The fee managing module 19 will allocate a specific ratio of the value-adding fee 129 to the designer 11.

The value-adding module 182 can also accept the designer's 11 commission for value addition and the value-adding fee 129 the designer 11 is willing to pay, and then add value to the industrial design draft A or industrial design work C provided by the designer 11. In this case, it is not necessary to allocate a specific ratio of the value-adding fee 129 to the designer 11 through the fee managing module 19.

The present invention has been described with preferred embodiments thereof and it is understood that the embodiments are not intended to limit the scope of the present invention. Moreover, as the content disclosed herein should be readily understood and can be implemented by a person skilled in the art, all equivalent changes or modifications which do not depart from the spirit of the present invention are encompassed by the appended claims.

1. An industrial-design-resources operating platform, located at a server end, for connecting a plurality of buyers and designers at client ends via the internet, the industrial-design-resources operating platform comprising:
a primary storage module, for storing a plurality of industrial design drafts sent by said designers;
a resource depository module, for depositing a plurality of industrial design works which correspond to said industrial design drafts and are accompanied with the evaluated classifications generated by a plurality of evaluators, wherein said evaluators comprise at least one internal evaluator and at least one external evaluator, wherein the internal evaluator is located at the industrial-design-resources operating platform at the server end, while the external evaluator is located at one of the client ends, retrieves the first industrial design draft from the industrial-design-resources operating platform, and sends the evaluated classification back to the industrial-design-resources operating platform;
a pricing module, for giving prices to said industrial design works according to said evaluated classifications;
a displaying module, for showing the priced industrial design works to said buyers, wherein said buyers having different browsing authorities browse said priced industrial design works under different classifications; and
a purchasing module, for accepting purchase fees paid by said buyers who have made purchase requests to some of said priced industrial design works.

2. The industrial-design-resources operating platform of claim 1, wherein the resource depository module comprises an internal resource depository module for depositing the industrial design work evaluated by the internal evaluator; and an external resource depository module for depositing the industrial design work evaluated by the external evaluator.

3. The industrial-design-resources operating platform of claim 2, wherein the displaying module comprises a first displaying sub-module for showing the industrial design works in the internal resource depository module after said industrial design work are priced; and a second displaying sub-module for showing the industrial design works in the external resource depository module after said industrial design works are priced.

4. The industrial-design-resources operating platform of claim 1, further comprising a fee managing module for allocating a specific ratio of the purchase fees paid by the buyers to the designer.

5. The industrial-design-resources operating platform of claim 1, wherein the purchasing module further comprises a verifying sub-module for verifying the buyers who made the purchase requests and verifying the industrial design works said buyers requested to purchase, before accepting the purchase fees paid by said buyers.

6. The industrial-design-resources operating platform of claim 1, wherein the buyers pay registration fees of different levels to the purchasing module in advance, in order to obtain different levels of the browsing authorities.

7. The industrial-design-resources operating platform of claim 1, further comprising a value-adding module for adding values to some of the industrial design drafts before the subsequent classifications by said evaluators.

8. The industrial-design-resources operating platform of claim 1, wherein the purchasing module further comprises a value-adding module for accepting the buyer's commission with a value-adding fee for value addition, and then adding more value to the industrial design work purchased by the buyer.

9. An industrial-design-resources operating platform, located at a server end, for connecting a plurality of buyers and designers at client ends via the internet, the industrial-design-resources operating platform comprising:
a primary storage module, for storing a plurality of industrial design drafts sent by said designers;
a resource depository module, for depositing a plurality of industrial design works which correspond to said industrial design drafts and are accompanied with the evaluated classifications generated by at least one evaluator, wherein the classifications are evaluated by said at least one evaluator according to the commercial potentials, the market values, or the concrete levels of said industrial design drafts;
a pricing module, for giving prices to said industrial design works according to said evaluated classifications;
a displaying module, for showing the priced industrial design works to said buyers, wherein said buyers having different browsing authorities browse said priced industrial design works under different classifications;
a purchasing module, for accepting purchase fees paid by said buyers who have made purchase requests to some of said priced industrial design works; and
a certifying module, whereby the designers are allowed to send the industrial design drafts only after the designers are certified, and the buyers are granted the correct browsing authorities only after the buyers are certified.

10. The industrial-design-resources operating platform of claim 9, wherein said at least one of said evaluators is located at the industrial-design-resources operating platform at the server end.

11. The industrial-design-resources operating platform of claim 9, wherein said at least one of said evaluators is located at one of the client ends for retrieving the industrial design drafts from the industrial-design-resources operating platform, and then sending the evaluated classifications back to said industrial-design-resources operating platform.

12. The industrial-design-resources operating platform of claim 9, further comprising a fee managing module for allocating a specific ratio of the purchase fees paid by the buyers to the designers of said purchased industrial design works.

13. The industrial-design-resources operating platform of claim 9, wherein the purchasing module further comprises a verifying sub-module for verifying the buyers who made the purchase requests and verifying the industrial design works said buyers requested to purchase, before accepting the purchase fees paid by said buyers.

14. The industrial-design-resources operating platform of claim 9, wherein the buyers pay registration fees of different levels to the purchasing module in advance, in order to obtain different levels of the browsing authorities.

15. The industrial-design-resources operating platform of claim 9, wherein the industrial design drafts are selected from the group consisting of two-dimensional drawings, three-dimensional drawings, animations, videos, schematic drawings, written descriptions, hand drawings, conceptual diagrams and physical design diagrams.

16. The industrial-design-resources operating platform of claim 9, further comprising a value-adding module for adding values to some of the industrial design drafts before the subsequent classifications.

17. The industrial-design-resources operating platform of claim 9, wherein the purchasing module further comprises a value-adding module for accepting the buyer's commission with a value-adding fee for value addition, and then adding more value to the industrial design work purchased by the buyer.

18. An industrial-design-resources operating platform, located at a server end, for connecting a plurality of buyers and designers at client ends via the internet, the industrial-design-resources operating platform comprising:
a primary storage module, for storing a plurality of industrial design drafts sent by said designers;
a resource depository module, for depositing a plurality of industrial design works which correspond to said industrial design drafts and are accompanied with the evaluated classifications generated by a plurality of evaluators, wherein said evaluators comprise at least one internal evaluator and at least one external evaluator, wherein the internal evaluator is located at the industrial-design-resources operating platform at the server end, while the external evaluator is located at one of the client ends, retrieves the first industrial design draft from the industrial-design-resources operating platform, and sends the evaluated classification back to the industrial-design-resources operating platform, the resource depository module further comprising an internal resource depository module for depositing the industrial design work evaluated by the internal evaluator; and an external resource depository module for depositing the industrial design work evaluated by the external evaluator; and
a displaying module, for showing the industrial design works to said buyers, wherein said buyers having different browsing authorities browse said priced industrial design works under different classifications, the displaying module further comprising a first displaying sub-module for showing the industrial design works in the internal resource depository module and a second displaying sub-module for showing the industrial design works in the external resource depository module.
